(19) United States
(12) Patent Application Publication
(10) Pub. No.: US 2026/0178321 A1
(43) Pub. Date: Jun. 25, 2026

(54) MIGRATING SOFTWARE APPLICATIONS FROM A CLOUD ENVIRONMENT TO A LOCAL SYSTEM

(71) Applicant: Red Hat, Inc., Raleigh, NC (US)

(72) Inventors: Leigh Griffin, Waterford (IE); Andrea Cosentino, Rome (IT); Paolo Antinori, Novara (IT)

(21) Appl. No.: 19/000,898

(22) Filed: Dec. 24, 2024

(51) Int. Cl. G06F 8/71

(52) U.S. Cl. CPC G06F 8/71

(57) ABSTRACT

Software applications can be migrated from a cloud environment to a local system. For example, a system can receive a first version of the software application stored in a first cloud environment and a second version of the software application stored in a second cloud environment. The system can determine a set of similarities between the versions and generate a first container layer for the software application based on the set of similarities. The system can generate a second container layer for the first version based on a difference between the set of similarities and the first version. The system stores the first container layer and the second container layer in a physical server. The first container layer and the second container layer can be used to execute the first version of the software application by enabling the first container layer and the second container layer in a container.

### TECHNICAL FIELD

The present disclosure relates generally to software application management. More specifically, but not by way of limitation, this disclosure relates to migrating software applications from a cloud environment to a local system.

### BACKGROUND

Software services such as applications, serverless functions, and microservices can be deployed inside containers within a computing environment. A container is a relatively isolated virtual computing environment created by leveraging the resource isolation features (e.g., cgroups and namespaces) of the Linux Kernel. Deploying software services inside containers can help isolate the software services from one another, which can improve speed and security and provide other benefits.

Containers are deployed from image files using a container engine, such as Docker or Podman. These image files are often referred to as container images. A container image can be conceptualized as a stacked arrangement of layers in which a base layer is positioned at the bottom and other layers are positioned above the base layer. The other layers may include a target software service and its dependencies, such as its libraries, binaries, and configuration files. The target software service may be configured to run (e.g., on a guest operating system) within the isolated context of the container.

### BRIEF DESCRIPTION OF THE DRAWINGS

FIG. 1 is a block diagram of an example of a computing environment for migrating software applications from a cloud environment to a local system according to one example of the present disclosure.

FIG. 2 is a block diagram of another example of a computing environment for migrating software applications from a cloud environment to a local system according to one example of the present disclosure.

FIG. 3 is a flowchart of a process for migrating software applications from a cloud environment to a local system according to one example of the present disclosure.

### DETAILED DESCRIPTION

Cloud computing can enable flexibility in device and location with respect to accessing computing resources. But, using cloud environments can introduce security risks, for example when configuration management is controlled by multiple users. A misconfigured cloud environment with public write access can result in data loss or security breaches by malicious actors. So, it may be beneficial to store and execute software application in certain ways that improve security and privacy protections. Accordingly, users may implement reverse cloud migration or cloud repatriation to move away from using the cloud environments to instead use on-premise infrastructure. But, to avoid vendor lock-in caused by using a sole cloud provider, the users may have employed a hybrid cloud environment that uses infrastructure from multiple cloud providers. Migrating away from the hybrid cloud environment to improve privacy protections can be complicated by the need to merge different versions of software applications being executed by the multiple cloud providers in the on-premise infrastructure. Otherwise, on-premise infrastructure may store a copy of each version of the software applications, leading to significant resource consumption.

Some examples of the present disclosure can overcome one or more of the issues mentioned above by migrating software applications from cloud environments to a local system such that the software applications are stored in an on-premise computing environment, such as a physical server. Using the on-premise computing environment can afford greater security protection compared to using a cloud environment, enabling a user to comply with privacy protections implemented according to a respective jurisdiction associated with a software application. For example, the on-premise computing environment may have consolidated management or predefined security parameters to enable relatively higher data privacy protections. In addition, the on-premise computing environment can store container layers associated with each version, where container layers for subsequent versions can build on top of container layers for previous versions. So, rather than storing each version, the footprint and resource consumption for software versions using container layers can be reduced.

Migrating a software application from the cloud environments to the on-premise computing environment can involve a system receiving a first version of the software application stored in a first cloud environment. The system can also receive a second version of the software application stored in a second cloud environment. The system can determine a set of similarities between the first version and the second version and generate a first container layer representing a base container layer for the software application based on the set of similarities. The system can generate a second container layer for the first version based on a first difference between the set of similarities and the first version. The system stores the first container layer and the second container layer in a physical server. The first container layer and the second container layer can be usable by the system to execute the first version of the software application by compiling and enabling the first container layer and the second container layer in a container. As such, the software application is moved on-premise using a smaller resource footprint than the cloud environments and in a manner that allows any version of the software application from the cloud environments to be executed by enabling the corresponding container layers for the version in a container. Once the software application versions are migrated to the on-premise computing environment, the versions stored in the cloud environments may be removed to conserve computing resources, such as memory space.

In one particular example, a computing device, such as a physical server, coupled to a two cloud environments—cloud environment A and cloud environment B can receive version A of a software application that is run cloud environment A. In addition, the physical server can receive version B of the software application that runs in the cloud environment B. The physical server determines the similarities between the source code of version A and version B and generates a base container layer from the similarities. The physical server also generates container layers based on differences between the versions and the similarities as well as differences between each other. For instance, if version A is a previous version of the software application than version B, the physical server can determine differences between version A and the similarities and generate container layer A based on the differences. For version B, the physical server can determine differences between version B and the similarities and generate container layer B1 based on the differences. In addition, the physical server can determine differences between version B and the version A and generate container layer B2 based on the differences. The physical server stores the base container layer, the container layer B1, and the container layer B2. Then, to execute version A of the software application, the physical server can generate a container that has the base container layer and the container layer A enabled. To execute version B of the software application, the physical server can generate a container that has the base container layer, the container layer B1, and the container layer B2 enabled. As such, any version of the software application from the cloud environments can be executed by enabling the corresponding container layers for the version in a container.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

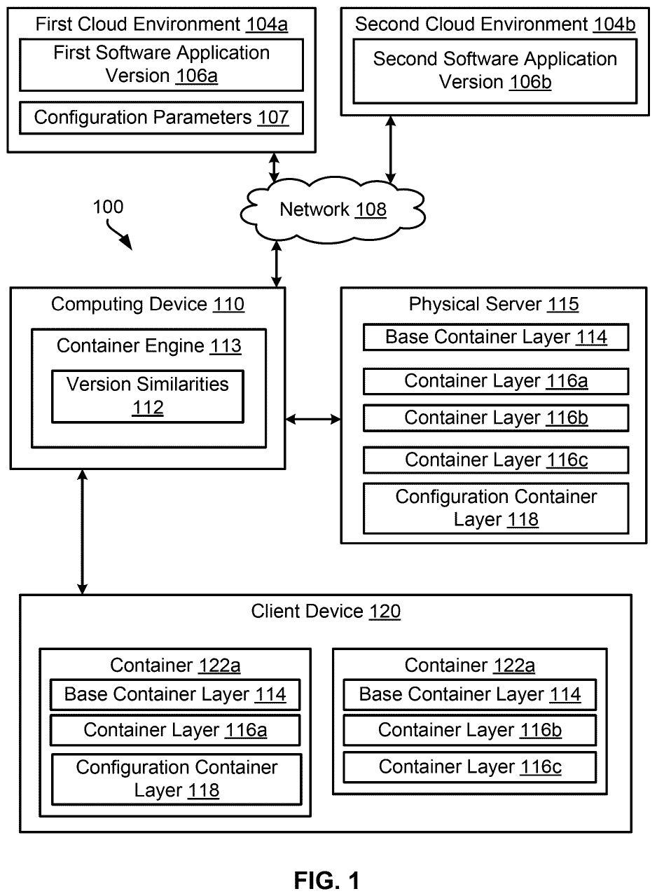

FIG. 1 is a block diagram of an example of a computing environment 100 for migrating software applications from a cloud environment 104 to a local system according to one example of the present disclosure. The local system can be an on-premise computing system with a physical server 115 to store software components related to a software application 106. Components within the computing environment 100 may be communicatively coupled via a network 108, such as a local area network (LAN), wide area network (WAN), the Internet, or any combination thereof. For example, the computing environment 100 can include a computing device 110 communicatively coupled to a first cloud environment 104a and a second cloud environment 104b that are communicatively through the network 108. The first cloud environment 104a may be provided by a different entity (e.g., cloud provider) than the second cloud environment 104b. Or, the first cloud environment 104a and the second cloud environment 104b may be provided by the same entity, but may differ in that the first cloud environment 104a (e.g., European west) may be associated with a different geological region than the second cloud environment 104b (European center).

The computing device 110 can also be communicatively coupled to the physical server 115, enabling the computing device 110 to migrate the software application 106 from the cloud environments 104a-b to the physical server 115. In some examples, the computing device 110 may be the physical server 115. Additionally, or alternatively, the computing device 110 may communicate with a different physical server using the network 108 to migrate the software application 106. Examples of cloud providers that host the cloud environments 104a-b can include Amazon Web Services (AWS), Microsoft Azure, International Business Machines Corporation (IBM), and Google Cloud Platform (GCP). Each cloud environment can include a respective version of the software application 106. For example, first cloud environment 104a can be associated with a first software application version 106a, the second cloud environment 104b can be associated with a second software application version 106b. The first software application version 106a and the second software application version 106b are different versions of the same software application.

In general, for each software application running in the cloud environments 104a-b, the computing device 110 can receive a name of the software application, a version of the software application, and configuration parameters for the software application. For example, the computing device 110 can receive an indication of the name of the software application, an indication of the version of the software application, and configuration parameters 107 from the first cloud environment 104a, where each of these properties are associated with the first software application version 106a. In addition, the computing device 110 can receive an indication of the name of the software application, an indication of the version of the software application, and configuration parameters from the second cloud environment 104b, where each of these properties are associated with the second software application version 106b.

Once the computing device 110 receives the first software application version 106a and the second software application version 106b, the computing device 110 may generate a data structure, such as an array, with an entry for each application having the same name, where each entry indicates the version and configuration parameters associated with a particular version. In addition, each entry can include a reference to source code for the software application version. That is, in this example, the data structure can include two entries associated with the software application, where a first entry includes the version, the configuration parameters 107, and a reference to the source code for the first software application version 106a, and where a second entry includes the version, the configuration parameters, and a reference to the source code for the second software application version 106b.

In some examples, a container engine 113 of the computing device 110 can then identify version similarities 112 between the first software application version 106a and the second software application version 106b. The version similarities 112 can be a set of similarities corresponding to a minimal application version. The minimum application version represents the lowest dependency of all of the variants of the software application across the cloud environments 104a-b and can become a candidate for a base software application. The container engine 113 can evaluate the source code for each instance of the software application in the data structure to determine the version similarities 112.

Upon determining the version similarities 112, the container engine 113 can generate a base container layer 114 for the software application, where the base container layer 114 corresponds to a containerized version of the version similarities 112. The container engine 113 can also generate container layers 116a-c corresponding to the software application versions 106a-b. To do so, the container engine 113 can determine a difference between each of the software application versions 106a-b and the base container layer 114, and optionally differences between the software application versions 106a-b themselves. These differences can be referred to as deltas, which the container engine 113 may determine using delta techniques (e.g., get diff or a delta RPM method). For each of the software application versions 106a-b, beginning with an earliest version (e.g., first software application version 106a), the container engine 113 can compare the version similarities 112 to the new variant of the software application to determine the difference. This process can repeat in a combinatorial manner where software application version N is compared with N+1, N+2 is compared with N and N+1, creating a set of differences.

As a particular example, if the first software application version 106a is an earlier version of the software application than the second software application version 106b, then the container engine 113 can compare the first software application version 106a (e.g., its source code) to the version similarities 112 to determine a first difference. The container engine 113 can generate the container layer 116a based on the first difference. In this way, a combination of the base container layer 114 and the container layer 116a corresponds to the first software application version 106a. In addition, the container engine 113 can compare the second software application version 106b (e.g., its source code) to the version similarities 112 to determine a second difference. The container engine 113 can generate the container layer 116b based on the second difference. For the second software application version 106b, since it is a subsequent version of the software application than the first software application version 106a, the container engine 113 can also compare the second software application version 106b to the first software application version 106c to determine a third difference and generate the container layer 116c based on the third difference. So, a combination of the base container layer 114 and the container layers 116b-c corresponds to the second software application version 106b.

In some examples, the container engine 113 can also generate a configuration container layer 118 based on the configuration parameters 107. For instance, upon receiving the configuration parameters 107 associated with the first software application version 106a, the container engine 113 can generate the configuration container layer 118 including the configuration parameters 107. The configuration container layer 118 may be a volume with a file that defines the configuration parameters 107, such as a database uniform resource locator (URL), a username, a password, etc. associated with the first software application version 106a in the first cloud environment 104a. The configuration container layer 118 can be usable with the base container layer 114 and the container layer 116a to execute the first software application version 106a in a way that mimics the execution of the first software application version 106a in the first cloud environment 104a.

Upon generating the base container layer 114, each of the container layers 116a-c, and the configuration container layer 118, the computing device 110 can store the base container layer 114, the container layers 116a-c, and the configuration container layer 118 in the physical server 115. In this way, the container layers are stored on a local system, such that the various versions of the software application in the cloud environments 104a-b can be replicated from the container layers with a reduced footprint than in the cloud environments 104a-b. The computing device 110 can store an association between each container layer and each version such that the computing device 110 can deploy a single container with a version of the software application. That version can be any version that existed in the cloud environments 104a-b and is compiled by taking the base container layer 114, the corresponding the container layers 116a-c, optionally a configuration layer to create a functioning software application housed in a container.

In some examples, the container engine 113 can also generate a feature flag in association with each container layer. The feature flag can be used to enable or disable the corresponding container layer and its dependencies. For example, by setting the feature flag to a first value (e.g., one) for a container layer, the container layer can be enabled, whereas by setting the feature flag to a second value (e.g., zero) for the container layer, the container layer can be disabled. So, when the container engine 113 generates a container for a particular version of the software application, the container may include each of the base container layer 114, the container layers 116a-c, and the configuration container layer 118. But, the feature flags may only be set to the first value for the container layer associated with the particular version. That is, for a container corresponding to the first software application version 106a, the container engine 113 can set the feature flags to the first value for the base container layer 114, the container layer 116a, and the configuration container layer 118 to enable these container layers, while setting the feature flags of the container layers 116b-c to the second value to disable these container layers.

In some examples, the computing device 110 can receive a request from the client device 120 to execute the first software application version 106a. In response to the request, the computing device 110 can generate a container 122a that includes the base container layer 114, the container layer 116a, and the configuration container layer 118. For each of these container layers, their corresponding feature flag can be enabled. Other container layers (e.g., the container layers 116b-c) may be included in the container 122a as well, but these other container layers can have their corresponding feature flags disabled so that these layers are not executed during execution of the container 122a. The computing device 110 can then cause an execution of the container 122a having the base container layer 114, the container layer 116a, and the configuration container layer 118 on the client device 120.

In some instances, in response to receiving the request, the computing device 110 may determine that a container 122b that is associated with the second software application version 106b is executing. The container 122b can be executing on the client device 120. The container 122b can include only the base container layer 114 and the container layers 116b-c based on these container layers corresponding to the second software application version 106b. Or, the container 122b can include additional container layers, where only the base container layer 114 and the container layers 116b-c are enabled using their feature flags. Prior to executing the container 122a, the computing device 110 can generate the container 122a in response to the request, where the container 122a includes the base container layer 114 and the container layer 116. The computing device 110 can then cause the execution of the container 122a while the container 122b is still deployed on the client device 120. Any traffic to the container 122b can be routed to the container 122a, and once all of the traffic is moved to the container 122a, the computing device 110 can deactivate the container 122b. Deactivating the container 122b may involve shutting down the container 122 on the client device 120 or removing the container 122b from the client device 120. In this way, the computing device 110 implements an A/B style approach to executing different versions of the software application on the client device 120 that results in minimal downtime, if any.

While FIG. 1 depicts a specific arrangement of components, other examples can include more components, fewer components, different components, or a different arrangement of the components shown in FIG. 1. For instance, while FIG. 1 is specific to generating container layers that correspond to different versions of a software application, virtual machines may be used instead. For example, each difference between the version similarities and the different software application versions can be implemented as a different storage layer that can be mounted on top of a virtual machine, similarly providing the mirroring of software application versions outside of the cloud environment. Additionally, any component or combination of components depicted in FIG. 1 can be used to implement the process(es) described herein. For instance, the computing device 110 and the physical server 115 may be the same device that generates and stores the container layers for the different versions of a software application.

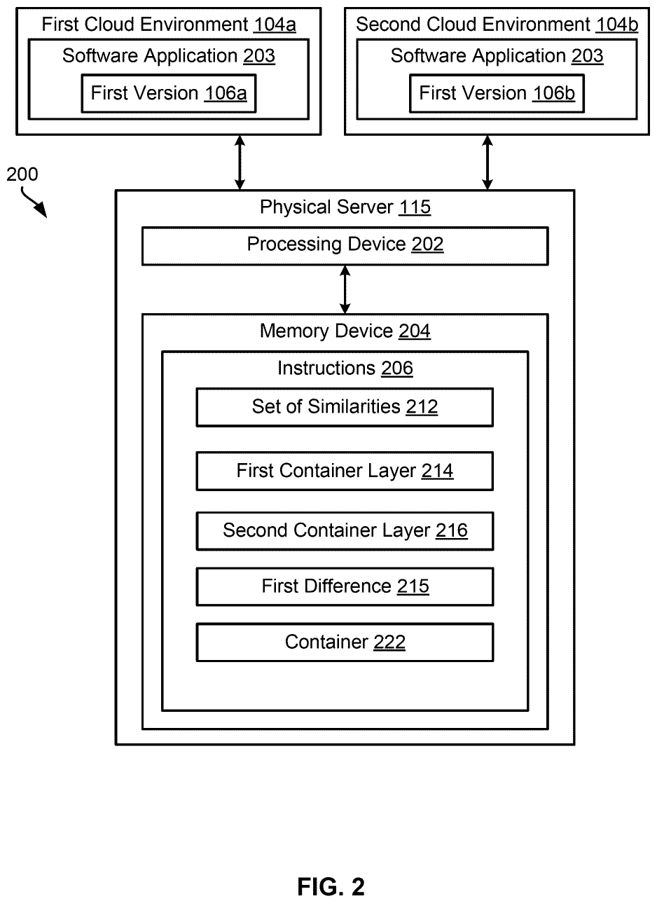

FIG. 2 is a block diagram of another example of a computing environment 200 for migrating software applications from a cloud environment 104 to a local system according to one example of the present disclosure. The computing environment 200 can include a physical server 115 containing a processing device 202 communicatively coupled to a memory device 204. The physical server 115 can be communicatively coupled to the cloud environment 104 to migrate the software application 203 from the cloud environment 104 to the physical server 115. Migrating the software application 203 can involve removing the software application 203 from the cloud environment 104 once the software application 203 is stored in the physical server 115.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the processing device 202 can execute the instructions 206 to perform operations. For example, the processing device 202 can receive a first version 106a of the software application 203 stored in a first cloud environment 104a. The processing device 202 can receive a second version 106b of the software application 203 stored in a second cloud environment 104b. The processing device 202 can determine a set of similarities 212 between the first version 106a and the second version 106b and generate a first container layer 214 based on the set of similarities 212. The first container layer 214 can be a base container layer for the software application 203. The processing device 202 can generate a second container layer 216 for the first version 106a based on a first difference 215 between the set of similarities 212 and the first version 106a. The processing device 202 can store the first container layer 214 and the second container layer 216 in the physical server 115. The first container layer 214 and the second container layer 216 can usable to execute the first version 106a of the software application 203 by enabling the first container layer 214 and the second container layer 216 in a container 222. As such, the software application 203 is moved on-premise using a smaller resource footprint than the cloud environments and in a manner that allows any version of the software application from the cloud environments to be executed by enabling the corresponding container layers for the version in a container.

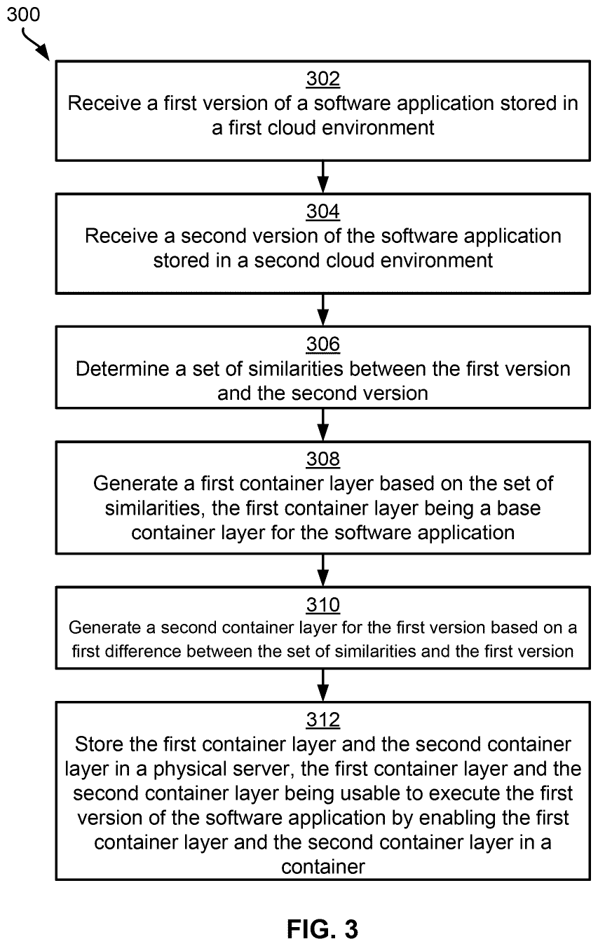

FIG. 3 is a flowchart of a process 300 for migrating software applications from a cloud environment 104 to a local system according to one example of the present disclosure. The local system can be an on-premise computing system with a physical server 115 to store the software application 203. In some examples, the processing device 202 can perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

In block 302, the processing device 202 receives a first version 106a of a software application 203 stored in a first cloud environment 104a. The first version 106a can be associated with configuration parameters 107 for running the software application 203 in the first cloud environment 104a. The configuration parameters can include access and authentication parameters, database parameters, environment variables, caching settings, network properties, and the like.

In block 304, the processing device 202 receives a second version 106b of the software application 203 stored in a second cloud environment 104b. The second version 106b can be associated with configuration parameters for running the software application 203 in the second cloud environment 104b. The second cloud environment 104b may be provided by a different entity or may be associated with a different geographic region than the first cloud environment 104a.

In block 306, the processing device 202 determines a set of similarities 212 between the first version 106a and the second version 106b. The processing device 202 can compare source code of the first version 106a and source code of the second version 106b to determine the set of similarities 212 between the first version 106a and the second version 106b. The set of similarities 212 represents the lowest dependency of all of the variants of the software application 203 in the cloud environments 104.

In block 308, the processing device 202 generates a first container layer 214 based on the set of similarities 212. The first container layer 214 is a base container layer for the software application 203. This means that each version of the software application 203 shares the set of similarities 212, and can thus be built on top of the first container layer 214.

In block 310, the processing device 202 generates a second container layer 216 for the first version 106a based on a first difference 215 between the set of similarities 212 and the first version 106a. So, the additional components and features of the first version 106a compared to the set of similarities 212 are captured by the first difference 215 and then containerized into the second container layer 216. In addition, container layers for the second version 106b can also be generated. These container layers can be generated based on a second difference between the set of similarities 212 and the second version 106b, as well as a third difference between the first version 106a and the second version 106b.

In block 312, the processing device 202 stores the first container layer 214 and the second container layer 216 in a physical server 115. The first container layer 214 and the second container layer 216 can be used by the processing device 202 to execute the first version 106a of the software application 203 on the physical server 115 or a client device 120 by enabling the first container layer 214 and the second container layer 216 in a container 222. Each of the first container layer 214, the second container layer 216, and any additional container layers generated for other versions of the software application 203 can include a feature flag that can be enabled or disabled. So, for executing the container 222 for the first version 106a of the software application 203, the feature flags for the first container layer 214 and the second container layer 216 can be enabled, while the feature flags for other container layers associated with other versions are disabled. In this way, the container layers are selectively enabled to mirror an execution of a particular version of the software application 203 outside of the cloud environments 104.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving a first version of a software application stored in a first cloud environment;
receiving a second version of the software application stored in a second cloud environment;
determining a set of similarities between the first version and the second version;
generating a first container layer based on the set of similarities, the first container layer being a base container layer for the software application;
generating a second container layer for the first version based on a first difference between the set of similarities and the first version; and
storing the first container layer and the second container layer in a physical server, the first container layer and the second container layer being usable to execute the first version of the software application by enabling the first container layer and the second container layer in a container.

2. The system of claim 1, wherein the operations further comprise:
generating a third container layer for the second version based on a second difference between the set of similarities and the second version;
generating a fourth container layer for the second version based on a third difference between the first version and the second version; and
storing the third container layer and the fourth container layer in the physical server, the third container layer and the fourth container layer being usable to execute the second version of the software application by enabling the first container layer, the third container layer, and the fourth container layer in the container.

3. The system of claim 1, wherein the operations further comprise:
receiving a set of configuration parameters associated with the first version of the software application in the first cloud environment;
generating a fifth container layer based on the set of configuration parameters; and
storing the fifth container layer in the physical server, the fifth container layer being usable to execute the first version of the software application by enabling the first container layer and the fifth container layer in the container.

4. The system of claim 1, wherein the operations further comprise:
receiving a request to execute the first version of the software application;
in response to the request, enabling the first container layer in the container using a first feature flag associated with the first container layer;
in response to the request, enabling the second container layer in the container using a second feature flag associated with the second container layer; and
executing the container having the first container layer and the second container layer enabled.

5. The system of claim 4, wherein the operations further comprise:
in response to the request, determining that a first container associated with the second version of the software application is executing; and
prior to executing the container, generating a second container including the first container layer and the second container layer being enabled, wherein the container comprises the second container.

6. The system of claim 5, wherein the operations further comprise:
subsequent to executing the second container, deactivating the first container.

7. The system of claim 1, wherein the first cloud environment is provided by a different entity than the second cloud environment, or wherein the first cloud environment is provided by a same entity as the second cloud environment and the first cloud environment is associated with a different geological region than the second cloud environment.

8. A method comprising:
receiving a first version of a software application stored in a first cloud environment;
receiving a second version of the software application stored in a second cloud environment;
determining a set of similarities between the first version and the second version;
generating a first container layer based on the set of similarities, the first container layer being a base container layer for the software application;
generating a second container layer for the first version based on a first difference between the set of similarities and the first version; and
storing the first container layer and the second container layer in a physical server, the first container layer and the second container layer being usable to execute the first version of the software application by enabling the first container layer and the second container layer in a container.

9. The method of claim 8, further comprising:
generating a third container layer for the second version based on a second difference between the set of similarities and the second version;
generating a fourth container layer for the second version based on a third difference between the first version and the second version; and
storing the third container layer and the fourth container layer in the physical server, the third container layer and the fourth container layer being usable to execute the second version of the software application by enabling the first container layer, the third container layer, and the fourth container layer in the container.

10. The method of claim 8, further comprising:
receiving a set of configuration parameters associated with the first version of the software application in the first cloud environment;
generating a fifth container layer based on the set of configuration parameters; and
storing the fifth container layer in the physical server, the fifth container layer being usable to execute the first version of the software application by enabling the first container layer and the fifth container layer in the container.

11. The method of claim 8, further comprising:
receiving a request to execute the first version of the software application;
in response to the request, enabling the first container layer in the container using a first feature flag associated with the first container layer;
in response to the request, enabling the second container layer in the container using a second feature flag associated with the second container layer; and
executing the container having the first container layer and the second container layer enabled.

12. The method of claim 11, further comprising:
in response to the request, determining that a first container associated with the second version of the software application is executing; and
prior to executing the container, generating a second container including the first container layer and the second container layer being enabled, wherein the container comprises the second container.

13. The method of claim 12, further comprising:
subsequent to executing the second container, deactivating the first container.

14. The method of claim 8, wherein the first cloud environment is provided by a different entity than the second cloud environment, or wherein the first cloud environment is provided by a same entity as the second cloud environment and the first cloud environment is associated with a different geological region than the second cloud environment.

15. A non-transitory computer-readable medium comprising program code executable by a processing device for causing the processing device to perform operations comprising:
receiving a first version of a software application stored in a first cloud environment;
receiving a second version of the software application stored in a second cloud environment;
determining a set of similarities between the first version and the second version;
generating a first container layer based on the set of similarities, the first container layer being a base container layer for the software application;
generating a second container layer for the first version based on a first difference between the set of similarities and the first version; and
storing the first container layer and the second container layer in a physical server, the first container layer and the second container layer being usable to execute the first version of the software application by enabling the first container layer and the second container layer in a container.

16. The non-transitory computer-readable medium of claim 15, wherein the operations further comprise:
generating a third container layer for the second version based on a second difference between the set of similarities and the second version;
generating a fourth container layer for the second version based on a third difference between the first version and the second version; and
storing the third container layer and the fourth container layer in the physical server, the third container layer and the fourth container layer being usable to execute the second version of the software application by enabling the first container layer, the third container layer, and the fourth container layer in the container.

17. The non-transitory computer-readable medium of claim 15, wherein the operations further comprise:
receiving a set of configuration parameters associated with the first version of the software application in the first cloud environment;
generating a fifth container layer based on the set of configuration parameters; and
storing the fifth container layer in the physical server, the fifth container layer being usable to execute the first version of the software application by enabling the first container layer and the fifth container layer in the container.

18. The non-transitory computer-readable medium of claim 15, wherein the operations further comprise:
receiving a request to execute the first version of the software application;
in response to the request, enabling the first container layer in the container using a first feature flag associated with the first container layer;
in response to the request, enabling the second container layer in the container using a second feature flag associated with the second container layer; and
executing the container having the first container layer and the second container layer enabled.

19. The non-transitory computer-readable medium of claim 18, wherein the operations further comprise:
in response to the request, determining that a first container associated with the second version of the software application is executing; and
prior to executing the container, generating a second container including the first container layer and the second container layer being enabled, wherein the container comprises the second container.

20. The non-transitory computer-readable medium of claim 15, wherein the first cloud environment is provided by a different entity than the second cloud environment, or wherein the first cloud environment is provided by a same entity as the second cloud environment and the first cloud environment is associated with a different geological region than the second cloud environment.
